(19) United States
(12) Patent Application Publication
(10) Pub. No.: US 2008/0199068 A1
(43) Pub. Date: Aug. 21, 2008

(54) Inspection System

(76) Inventors: David W. Duquette, Minneapolis, MN (US); Steven K. Case, St. Louis Park, MN (US); Paul R. Haugen, Bloomington, MN (US)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 11/972,260

(22) Filed: Jan. 10, 2008

Related U.S. Application Data
(60) Provisional application No. 60/879,720, filed on Jan. 10, 2007.

(51) Int. Cl. G06K 9/00

(52) U.S. Cl. 382/145

(57) ABSTRACT

An inspection system for inspecting web printed electronic circuitry includes a strobed illuminator, a detector, a motion encoder, and a processor. The strobed illuminator is adapted to project light through a reticle to project a pattern of light onto an area of the web. The projected light occurs in a pulse sufficiently short to essentially freeze the web motion. The system projects the pattern of light onto the area of the web in at least two different positions of the web each position corresponding to a different phase of the projected light. A detector is adapted to acquire at least two images of the area, each image corresponding to one of the at least two different phases. The motion encoder provides a position output relative to a position of the web. The processor is coupled to the encoder, the illuminator and the detector. The processor is adapted to synchronize the illuminator with the web motion to expose the area of the web. The processor co-sites the at least two images and can construct a height map image with the co-sited images.

### CROSS-REFERENCE TO RELATED APPLICATION

The present application is based on and claims the benefit of U.S. provisional patent application Ser. No. 60/879,720, filed Jan. 10, 2007, the content of which is hereby incorporated by reference in its entirety.

### BACKGROUND

Electronics circuitry manufactured using variations on standard printing techniques has been demonstrated. During the printing process, various conducting, insulating, and semiconducting layers are deposited on a substrate. The materials in these layers take the place of inks in conventional printing. Once all of the layers have been deposited and cured, the result is a working electronic device that can be produced at high volume and at low cost.

Feature size and layer thickness in prototype production runs are in the range of a few microns to a few hundred microns. These features will likely shrink in size as new materials are developed for higher performance applications.

The area, thickness, and registration of various layers are important to the correct functioning of the printed circuit components. Some of the materials, particularly precious-metal based conductive inks, can be costly to waste. The speed with which reel-to-reel or web printing processes can run means that processes must remain under tight control to avoid the manufacture of large volumes of non-functioning product.

### SUMMARY

An inspection system for inspecting web printed electronic circuitry includes a strobed illuminator, a detector, a motion encoder, and a processor. The strobed illuminator is adapted to project light through a reticle to project a pattern of light onto an area of the web. The projected light occurs in a pulse sufficiently short to essentially freeze the web motion. The system projects the pattern of light onto the area of the web in at least two different positions of the web each position corresponding to a different phase of the projected light. A detector is adapted to acquire at least two images of the area, each image corresponding to one of the at least two different phases. The motion encoder provides a position output relative to a position of the web. The processor is coupled to the encoder, the illuminator and the detector. The processor is adapted to synchronize the illuminator with the web motion to expose the area of the web. The processor co-sites the at least two images and can construct a height map image with the co-sited images.

### BRIEF DESCRIPTION OF THE DRAWINGS

FIG. 1 is a diagrammatic view of a web printing process for manufacturing printed electronic circuitry in accordance with an embodiment of the present invention.

FIG. 2 is a diagrammatic view of an electronic component disposed on a substrate.

FIG. 3 is a diagrammatic view of a three-dimensional inspection system in accordance with an embodiment of the present invention.

FIG. 4 is a diagrammatic view of a printed circuit inspection system in accordance with another embodiment of the present invention.

FIG. 5 is a diagrammatic view of a portion of a web in accordance with an embodiment of the present invention.

### DETAILED DESCRIPTION OF ILLUSTRATIVE EMBODIMENTS

Three-dimensional inspection systems for printed electronic circuitry should be capable of micron-level accuracy while being able to perform inspections during high-speed web processing. Various embodiments of the present invention generally employ a technique for mapping, or otherwise measuring, height of features on a web. Three-dimensional phase profilometry is a known technique. See, for example, U.S. Pat. Nos. 6,049,384 and 6,750,899, which patents issued to the assignee of the current application. Essentially, a light pattern is projected onto a substrate and is analogous to the pattern of dark and light areas cast onto a floor by sunlight passing through a Venetian blind. Just as the sunlight passing through a Venetian blind will present a pattern of parallel, straight stripes on a flat floor, the pattern of light on a flat surface, will be one of parallel, straight stripes, but varying in intensity according to the sinusoidal pattern of opacity of the reticle. Continuing the analogy to sunlight passing through a Venetian blind, it will be understood that when viewed from above, the pattern of stripes of sunlight will be shifted laterally if they strike an object (like a sleeping cat) having a height different from the height of the flat floor. Similarly, because the light is projected onto a flat surface at an angle to the plane of the flat surface, the pattern of stripes presented on the flat surface is shifted laterally from the presence of an object having a height different from the height of the flat surface.

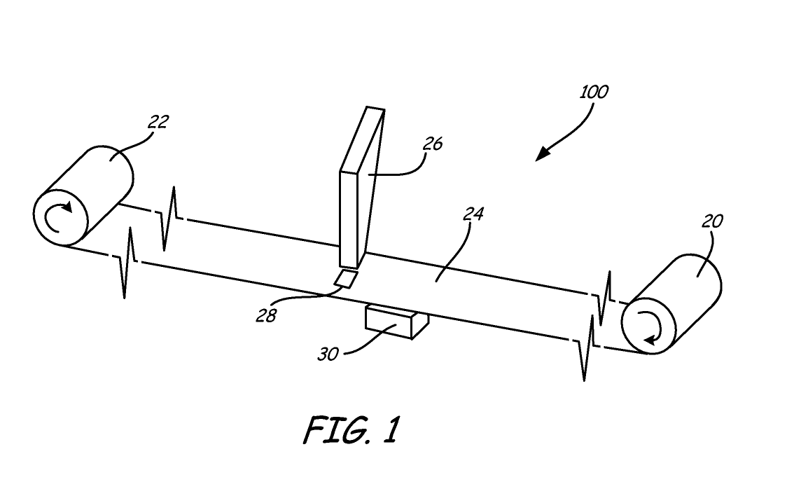

FIG. 1 is a diagrammatic view of a web printing process for manufacturing printed electronic circuitry in accordance with an embodiment of the present invention. The web proceeds from a source reel 20 to a take-up reel 22 with manufacturing steps occurring in the flat region 24 of the web. During manufacture, it is important that portions of the web not be stopped, since such stoppage would require the use of a complex intermediate take-up system. Additionally, it is also important that the entire web process not be stopped since some manufacturing portions may be exposed to time-sensitive processes, such as chemical etching, or deposition, where such stoppage would unduly add to the process time. Accordingly, in order to efficiently manufacture printed circuits using the web-process illustrated in FIG. 1, the speed with which the web travels should be maintained at a constant rate from source reel 20 to take-up reel 22.

Sensor 26 is disposed to acquire an image of a portion, or field of view, 28 on web 24. Sensor 26 may include a stroboscopic illuminator, or may be coupled to one or more stroboscopic illuminators. The stroboscopic illuminator(s) is/are configured to fire a pulse of illumination that essentially freezes the motion of the web during image acquisition. In this regard, even though web 24 undergoes continuous motion, a number of clear, stop-action, images can be acquired. Each of the stroboscopic illuminator(s) is coupled to a reticle such that sequentially-fired bursts of illumination produce differing phases or fringe patterns at each discrete location in the image. Web motion encoder 30 provides a signal to a controller within sensor 26, or coupled to sensor 26, that is indicative of the relative displacement of web 24 between sequential firings of different-phase image acquisitions. In this manner, the motion signal can be used to co-site the temporally-spaced images so that the only difference in the image is that of the phase or fringe patterns. Accordingly, processing of the fringe patterns can then be effected in accordance with known techniques to derive height characteristics of features on the web.

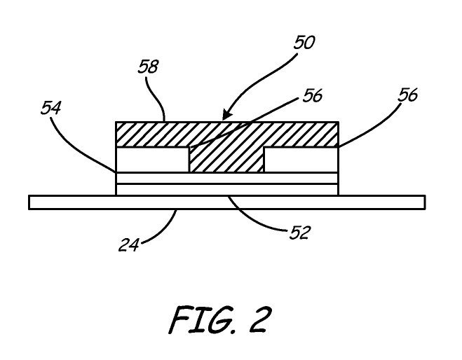

FIG. 2 is a diagrammatic view of an electronic component 50 disposed on substrate 24. Device 50 includes a conducting layer 52 disposed on an adjacent substrate 24. Additionally, an insulating layer 54 is disposed on top of conducting layer 52. Next, conducting layers 56 are patterned, or otherwise disposed, upon insulating layer 54. Finally, a semiconducting layer 58 is disposed on and between conducting layers 56. Device 50 is merely one example of a printed circuit component that can be manufactured using web-techniques. Additionally, embodiments of the present invention are generally applicable to any web-based manufacturing process that produces products of varying height where the height can be indicative of good or bad product. For example, embodiments of the present invention can be applied to the manufacture of flexible circuitry, etched-foil heaters, solar cells, hydrogen fuel cells, or any other suitable devices.

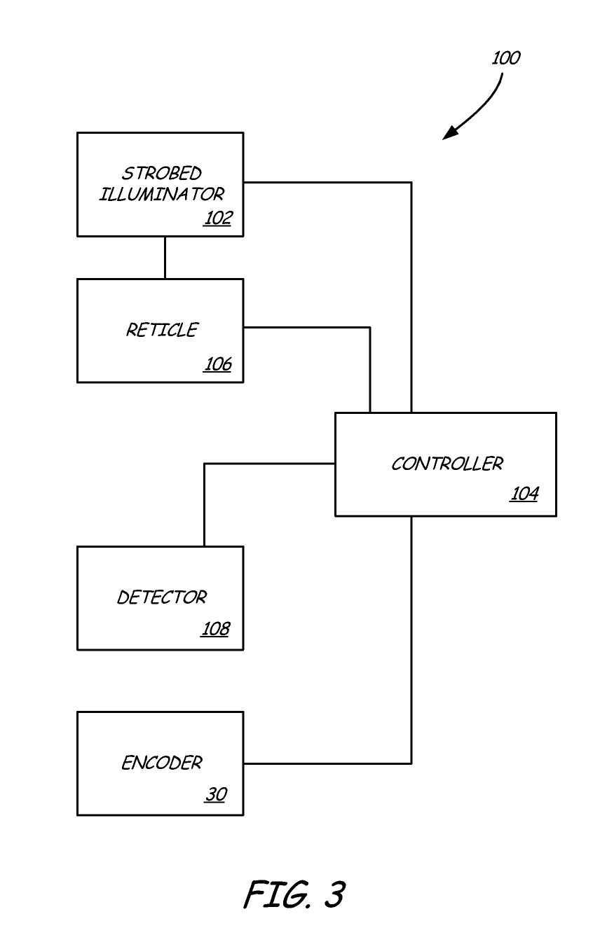

FIG. 3 is a diagrammatic view of a three-dimensional inspection system in accordance with an embodiment of the present invention. System 100 includes a strobed illuminator 102 coupled to controller 104. Strobed illuminator 102 is optically coupled to reticle 106, which imparts a pattern upon the illumination from illuminator 102 passing therethrough. In some embodiments, reticle 106 may be configured to generate different phase or fringe patterns, and in such embodiments, reticle 106 is coupled to controller 104 such that the selection of the fringe pattern can be determined by controller 104. However, in other embodiments where multiple strobed illuminators are used, each illuminator may have its own fixed reticle, and in such cases, the reticles need not be coupled to controller 104. Motion encoder 30 is coupled to controller 104 such that motion of the web between successive image acquisitions can be measured, thereby allowing the successive images to be co-sited, or otherwise arranged, such that they completely align with one another, so that the only differences in the images are due to different fringe patterns. System 100 also includes detector 108 coupled to controller 104. Detector 108 can be any suitable image acquisition device, such as a CCD array, a CMOS detector, or other appropriate device. Preferably, detector 108 has an optical axis that is disposed to view the area 28 from an angle different than the angle of illumination from the strobed illuminator(s). As set forth above, the strobed illuminator, reticle, detector and controller may all be embodied within a single enclosure, or they may be coupled to one another while embodied in separate enclosures.

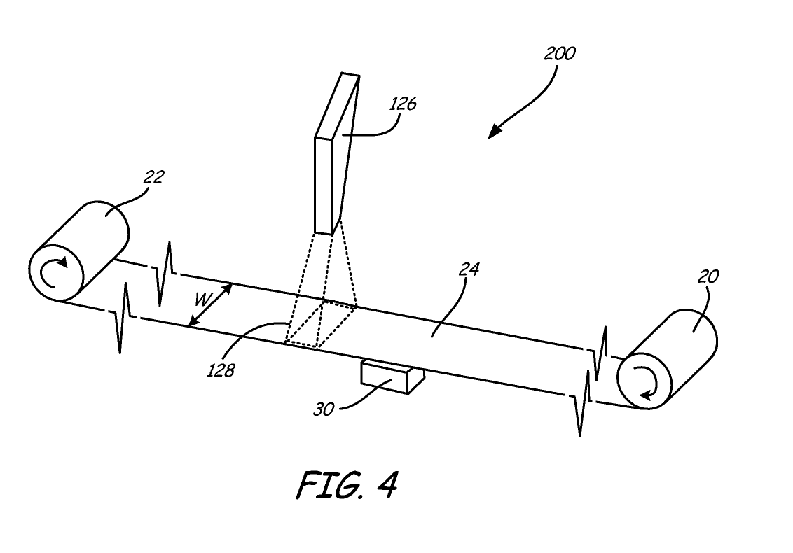

FIG. 4 is a diagrammatic view of a printed circuit inspection system in accordance with another embodiment of the present invention. System 200 is similar to the system illustrated with respect to FIG. 1 and like components are numbered similarly. The main difference between the system 200 illustrated in FIG. 4 and that described above, is that sensor 126 has a field of view 128 that covers the entire width W of web 24. Accordingly, embodiments of the present invention include the acquisition of images with fields of view smaller than the width of the web, and images having a field of view that is as large as the entire width of the web 24. While current image processing techniques may render embodiments that acquire images of the entire web difficult to be practiced using current technology, it is certainly contemplated that both image processing techniques and computational efficiency will likely improve in the future, and that embodiments that capture images of the entire width of the web may ultimately be simpler to implement.

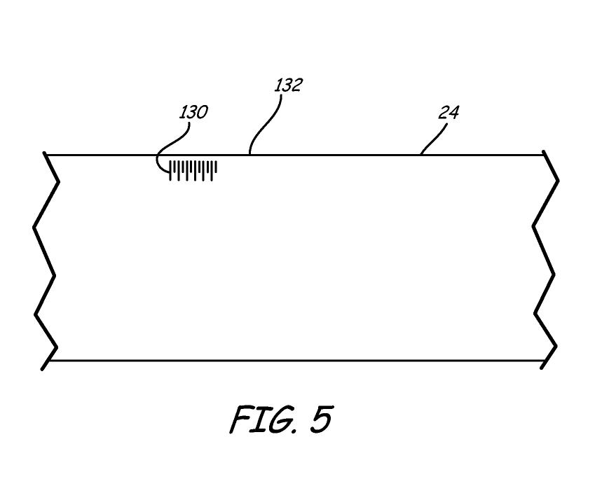

FIG. 5 is a diagrammatic view of a portion of web 24 in accordance with an embodiment of the present invention. Since web 24 will contain many panels of components or circuits, or patterns, it is important that the inspection system be triggered reliably and efficiently based upon the exact motion of the web 24. Accordingly, it is preferred that web 24 be provided with some pre-defined pattern, preferably proximate an edge of web 24, that can be read by a sensor, or even motion encoder 30, to synchronize the timings of image acquisition. Accordingly, FIG. 5 illustrates one exemplary target 130 disposed proximate edge 132 of web 24. When target 130 is read by a suitable sensor (not shown in FIG. 5), the controller will know that the web is at a pre-defined position relative to panels, components, or circuits, disposed thereon. Accordingly, a pre-selected regimen of image acquisitions can be performed to acquire three-dimensional image information relative to one or more circuits, features, or other characteristics of web 24.

While embodiments of the present invention can be practiced using two distinct phase patterns or fringe patterns, it is preferable to employ three distinct phase patterns. The utilization of at least three patterns produces height maps that are unaffected by reflectivity and illumination changes and simplifies computations. Additionally, it is expressly contemplated that four or more phase patterns can also be used in accordance with embodiments of the present invention.

In order to increase vibrational immunity of the inspection system, it is preferred that the successive acquisition of at least two images be accomplished within a relatively short period of time, such as two milliseconds. In this way, even a system that is undergoing vibration will have moved relatively little in the time between image acquisitions. This is important because while the web encoder will provide a signal relative to the motion of the web between successive image acquisitions, vibration of the system may result in a displacement in any direction, and that displacement may not be fully transduced by the web motion encoder. Accordingly, vibration does have the ability to introduce error, and it is important to ameliorate its effects.

Embodiments of the present invention generally provide the ability to obtain three-dimensional information of the components, circuits, or features on web 24. Since the images themselves contain two-dimensional information relative to those circuits, features, or patterns, the provision of a height map allows the volume of each such circuit, component, feature, or circuit to be calculated. This quantity can be used to inspect web 24 in real-time.

In accordance with another embodiment of the present invention, the system includes a low-resolution, high-speed mode wherein data from a plurality of pixels in image detector 108 are combined to form a larger effective pixel. This larger effective pixel allows for higher-speed applications.

Finally, embodiments of the present invention also include the detection or measurement of the height of web 24 itself. This is important because if web 24 is deformed, to some extent, during processing, calculations that assume web 24 is flat, may unduly affect height computations of components. Accordingly, it is contemplated that areas of web 24 that are known to have no components, features, or circuits, may be observed by sensor 26 to determine the height of web 24. Further, a plurality of three or more observations can be acquired to generate a three-dimensional plane that approximates web 24. Further, one or more sensors can be used to simply determine the height of web 24 proximate field of view 28. Such sensors include known laser-triangulation sensors, distance sensors, or any other suitable sensors.

Although the present invention has been described with reference to preferred embodiments, workers skilled in the art will recognize that changes may be made in form and detail without departing from the spirit and scope of the invention.

What is claimed is:

1. An inspection system for inspecting web printed electronic circuitry, the system comprising:
a strobed illuminator adapted to project light through a reticle to project a pattern of light onto an area of the web, the projected light occurring in a pulse sufficiently short to essentially freeze the web motion, the system projecting the pattern of light onto the area of the web in at least two different positions of the web each position corresponding to a different phase of the projected light;
a detector adapted to acquire at least two images of the area, each image corresponding to one of the at least two different phases;
an encoder providing a position output relative to a position of the web; and
a processor coupled to the encoder, the illuminator and the detector, the processor adapted to synchronize the illuminator with the web motion to expose the area of the web, the processor co-siting the at least two images and to construct a height map image with the co-sited images.

2. The system of claim 1, where the inspection system inspects various layers of a printed electronic circuit.

3. The system of claim 1, wherein the strobed illuminator is energized at least two times within a fixed period of time.

4. The system of claim 1, wherein:
the detector is further adapted to acquire an additional image of the area; and
the processor operates upon three images of the area to provide the compensated height map.

5. The system of claim 1, wherein the detector includes a plurality of pixels, and wherein the detector is operable in a first and a second mode, the second mode accomplished by combining data from the pixels into equivalent data for an equivalent pixel, where the equivalent pixel is larger in effective area than the pixel.

6. A method for inspecting a moving target, the method comprising:
illuminating a printed electronic circuitry feature with a pattern of light;
encoding a position of the target;
acquiring at least two images of the target at two distinct positions of the target, the two images being acquired as a function of the target position; and
calculating a height of the target based upon the at least two acquired images.

7. The method of claim 6, further comprising acquiring an additional image of the target at another distinct position of the target, wherein the step of calculating the height is computed as a function of the at least two acquired images and the additional image.

8. An inspection system for inspecting web-printed electronic circuitry, the system comprising:
an illuminator adapted to project light through a reticle so as to project a pattern of light onto an area of the web, wherein the projected light occurs in a pulse sufficiently short to essentially freeze the web motion;
wherein the system projects the pattern of light onto the area of the web in at least two different positions of the web, each position corresponding to a different phase of the projected light;
a detector having an optical axis and adapted to acquire at least two images of the area, each image corresponding to one of the at least two different phases, wherein the area is displaced in a direction having a component perpendicular to the optical axis between acquisition of the at least two images;
an encoder providing a position output giving the position of the web; and
a processor coupled to the encoder, the illuminator and the detector, the processor adapted to synchronize the illuminator with the web motion to expose the area of the web, the processor co-siting the at least two images and to construct a height map image with the co-sited images.

9. The system of claim 8, wherein the illuminator is a strobed illuminator, and wherein the detector acquires the at least two images during relative motion between the detector and the area.

10. An inspection system for inspecting web printed electronic circuitry, the inspection system comprising:
an illuminator adapted to project light through a reticle so as to project a pattern of light onto an area of the web, the projected light occurring in a pulse sufficiently short to freeze the web motion;
the system projecting the pattern of light onto the area of the web in at least two different positions of the web, each position corresponding to a different phase of the projected light;
a detector having an optical axis disposed to view the area from an angle different than the angle of illumination, the detector being adapted to acquire at least two images of the area, each image corresponding to one of the at least two different phases, wherein the area is displaced in a direction having a component perpendicular to the optical axis between acquisition of the at least two images;
an encoder outputting a position output giving the position of the web; and
a processor coupled to the encoder, the illuminator and the detector, the processor being adapted to synchronize the illuminator with the web motion to expose the area of the web, the processor being further adapted to co-site the at least two images and to construct a height map image with the co-sited images.

11. A system for inspecting web-based manufacturing, the system comprising:
at least one strobed illuminator configured to generate a plurality of pulses of patterned illumination, each of the plurality of pulses having a different phase;
an image detector configured to acquire at least two successive images of a field of view on the web, wherein each successive image corresponds to a respective pulse of differently patterned illumination;
a web motion encoder configured to measure web motion between successive image acquisitions; and
a controller coupled to the at least one strobed illuminator, the image detector and the web motion encoder, the controller being configured to use the measured web-motion to co-site the successive images and then create a height map of the field of view based on the co-sited successive images.

12. The system of claim 11, wherein the at least one strobed illuminator is optically coupled to a reticle, and wherein the reticle is also coupled to the controller.

13. The system of claim 11, wherein the pattern of illumination is a sinusoidally varying intensity pattern.

14. The system of claim 11, wherein the web includes at least one target disposed thereon such that cycles of image acquisition are triggered from target detections.
